(19) United States
(12) Patent Application Publication
(10) Pub. No.: US 2009/0325597 A1
(43) Pub. Date: Dec. 31, 2009

(54) METHOD AND APPARATUS FOR OPTIMIZING MOBILITY OF A MOBILE DEVICE

(75) Inventors: Jeffrey D. Smith, Sunrise, FL (US); Andor Almasi, Sunrise, FL (US)

Correspondence Address: MOTOROLA, INC, 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/165,609

(22) Filed: Jun. 30, 2008

(51) Int. Cl. H04Q 7/20

(52) U.S. Cl. 455/456.1

(57) ABSTRACT

The application discloses a method and apparatus for optimizing mobility of a mobile device in the wireless communication system. The method includes receiving (302) a plurality of mobility area descriptors from an external device, and configuring (304) the received plurality of mobility area descriptors in the mobile device. The method then determines (306) a current location of the mobile device (110), and selects (308) a mobility area descriptor among the plurality of mobility area descriptors based on the current location of the mobile device (110). The mobility area descriptor is associated with a geographical area (112) in the communication system. The method then finally optimizes the optimizing (310) the mobility of the mobile device (110) based on the selected mobility area descriptor.

### FIELD OF THE DISCLOSURE

The present disclosure relates generally to a wireless communication system and more particularly to a method and apparatus for optimizing mobility of a mobile device in the wireless communication system.

### BACKGROUND

In a wireless communication system, a service area is typically divided into a plurality of cells, with each cell being served by a base station. A cell includes at least one mobile device that establishes communication with the corresponding base station positioned at the centre of the cell. However, during mobility of the mobile device, the mobile device may move to the edge of the cell, or move from one cell to another cell. As a result, signal strength in the cell drops and the mobile device may lose communication with the base station. Thus, to improve mobility of the mobile device and to provide acceptable signal standards, the mobile device needs to continually measure the signal strengths from adjacent cells. If the signal strength of the current cell is determined to be lower than that of another cell by a certain threshold, a process called handoff is initiated.

In the existing technology, to perform handoff, different types of handoff algorithms are implemented in the mobile device. One of the existing handoff algorithms is a RSSI algorithm that is used for improving the mobility of the mobile device in the wireless communication system. In the RSSI algorithm, the handoff is based on received signal strength information. The RSSI algorithm seeks out the cell with the best signal strength. Existing RSSI algorithms, however, have several drawbacks.

Firstly, the RSSI algorithm may break down due to delays in collecting samples from adjacent cells indicating their signal strength and interference levels. In such cases, signal strength information of the adjacent cell becomes outdated, which may lead to drop of service quality for the mobile device.

Secondly, the mobile device may move into an area called a dead spot, where there is a lack of RF coverage from a particular cell or adjacent cells. While in the dead spot, the mobile device will penalize the channel of that particular cell by attempting to search for a better adjacent cell. When the mobile device exits the dead spot, the RSSI algorithm will attempt to switch the mobile device away from the currently penalized channel of the particular cell. This switch can force the mobile device to leave the current channel associated with the particular cell, which may be the best channel outside of the dead spot. Leaving the current channel may result in the mobile device landing on a new channel associated with another cell upon which operation is not expected.

Accordingly, there exists a need for optimizing mobility of the mobile device in a wireless communication system.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a schematic of a wireless communication system in accordance with some embodiments.

FIG. 2 is a block diagram of a mobile device and an external device along with a table of mobility area descriptors in accordance with some embodiments.

FIG. 3 is a flowchart of a method for optimizing mobility of a mobile device in accordance with some embodiments.

FIG. 4 is a detailed flowchart of a method for optimizing the mobility of a mobile device in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The present disclosure is directed towards a method of operating a mobile device to optimize mobility of the mobile device in a communication system. The method includes receiving a plurality of mobility area descriptors from an external device, and configuring the received plurality of mobility area descriptors in the mobile device. The method further includes determining a current location of the mobile device, and selecting a mobility area descriptor among the plurality of mobility area descriptors based on the current location of the mobile device. The mobility area descriptor is associated with a geographical area in the communication system. The method finally includes optimizing the mobility of the mobile device based on the selected mobility area descriptor.

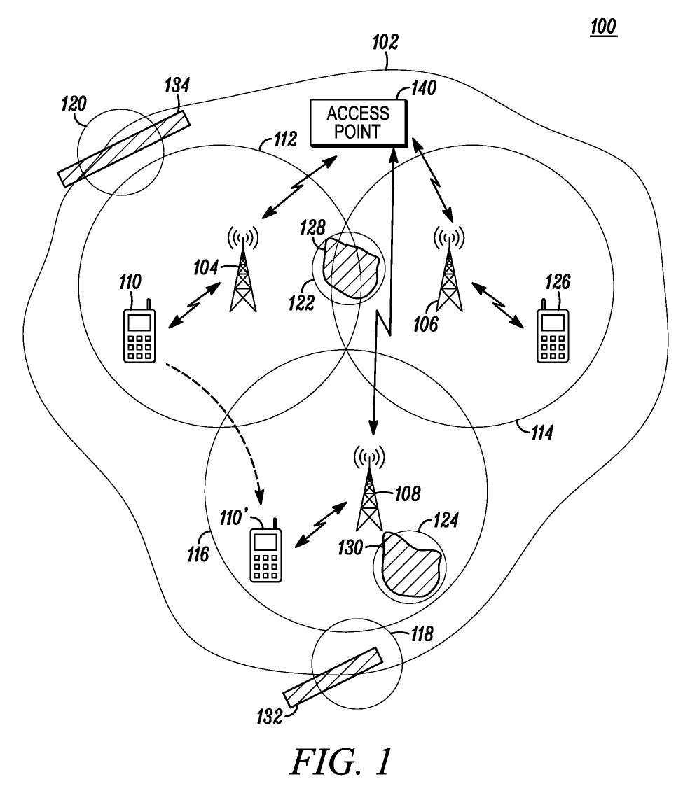

FIG. 1 illustrates a schematic of a wireless communication system in accordance with some embodiments. The wireless communication system 100 is divided into a plurality of zones (not shown), and each zone is further divided into a plurality of sites, an example of which is represented by site 102. Each site 102 includes an access point 140 and a plurality of mobile devices 110,126 located at different positions in the corresponding site 102. Each access point operates at a different frequency while providing communication to the mobile devices. For example, the access point 140 in the site 102 operates on a frequency that is different from a frequency associated with an adjacent site (not shown).

Further, the site 102 is divided into a plurality of geographical areas 112,114,116,118,120,122. Each geographical area may be a coverage area or a dead spot. The coverage area, for example geographical area 112,114,116, is an area in which the mobile devices establish continuous or uninterrupted communication with the access point. Each coverage area includes a tower 104,106,108 that is communicatively coupled to the access point and each tower operates at a single frequency to establish communication with the mobile device 110. For example, the tower 104 operates on a frequency that is same as the frequency associated with the tower 106.

On the other hand, the dead spot, for example geographical area 118, 120, 122, 124, is an area within which the mobile devices 110, 126 establish discontinuous/interrupted communication with the access point 140. In some instances, the access point 140 provides no communication to the mobile devices 110, 126 residing in the dead spot 122. In one example, building structures 128, 130 may be considered as dead spots as the mobile devices may receive weak signal or interrupted signal from the tower or access point. The dead spot may be located within the site or may be a part of one or more sites. For example, the dead spot 118 is a part of site 102 and another site (not shown) that is adjacent to the site 102. In another example, the dead spot 124 is within the coverage area 116 and thus the dead spot is a part of only one site 102.

In accordance with the embodiment, the mobile devices 110, 126 may move anywhere in the communication system 100. For example, the mobile device 110 may move from one site to another site, or may move from one geographical area to another geographical area. In FIG. 1, the movement of mobile device 110 from geographical area 112 to geographical area 116 is shown with dotted lines, and the mobile device 110 in the newly moved geographical area 116 is represented as the mobile device 110′. Also, current location of the mobile device 110 is determined and updated by employing a global positioning system (GPS) tracking onboard receiver or other tracking system.

In accordance with the embodiment, the mobile devices 110, 126 are configured to receive a plurality of mobility area descriptors from an external device 150. The external device may be a “mobile device configuration software (MDCS)” device (not shown), an access point 140, or any other similar device that can provide mobility area descriptors to the mobile devices 110, 126. MDCS may be software that includes functionality of selecting mobility area descriptors corresponding to the mobile devices 110, 126, and configuring such selected mobility area descriptors into the mobile devices 110, 126. Each mobility area descriptor is associated with a geographical area in the communication system. The mobility area descriptors provide information on the geographical area to be selected when the mobile device first enters the site. In another embodiment, the mobility area descriptors provide information of a control channel associated with a new site to be selected when the mobile device 110 faces discontinuous or interrupted communication with the current site 102 or access point 140. In general, the mobility area descriptors in the mobile device 110 are utilized to optimize the mobility of the mobile device in the communication system 100.

In accordance with the embodiment, the mobile devices 110, 126 in the communication system 100 may be a wireless device, a mobile station, a user equipment, an APCO 25 trunked radio, or any similar device that can transmit and receive signals. The mobile devices 110, 126 are configured to operate according to any of a number of different 2G, 3G and 4G wireless communication technologies.

In accordance with the embodiment, the access point 140 and the towers 104-108 are configured to operate according to any of a number of different 2G, 3G and 4G wireless communication technologies. These include Global System for Mobile Communication (GSM), Code Division for Multiple Access (CDMA), Universal Mobile Telecommunication System (UMTS), Wideband Code Division for Multiple Access (W-CDMA), Orthogonal Frequency Division Multiplexing (OFDM), Worldwide Interoperability for Microwave Access (WiMax), Long-Term Evolution (LTE) and other communication technologies. Access point 140 can be a base station or an access node that transmit and receive signals to and from mobile devices 110, 126 via corresponding towers 104-108 and other devices operating within the communication system 100.

In addition, the access point 140 transmits and receives signals between different access points and network infrastructure components (not shown) that provide wireless communication to the mobile devices operating within the communication system 100. The communication system 100 may further include various additional entities, such as base site controllers, billing, authorization, authentication, and voice mail servers that are not directly relevant to the present discussions. It is possible that neighboring communication systems can operate using the same or different communication technologies. The access point 140 may also communicate with other access points (not shown) or with any other device using an IEEE 802.16-based wireless metropolitan area network or other technologies. The embodiments described focus on establishing communication between the access points and the mobile devices residing in the communication system 100.

Operationally, the mobile device 110 receives the plurality of mobility area descriptors from an external device 150, for example, the external device may be an access point 140 or a device that has “mobile device configuration software (MDCS).” The mobile device 110 then configures or stores such received mobility area descriptors in the mobile device 110. The mobile device 110 further determines its current location in the communication system 100 by employing a global positioning system (GPS) tracking onboard receiver or other tracking system.

Further, when the mobile device 110 enters a new site or faces communication problems in the current site 102, the mobile device 110 selects a mobility area descriptor among the plurality of mobility area descriptors based on the current location of the mobile device 110. In one example, the mobility area descriptor is associated with a geographical area 112. The mobile device 110 then optimizes its mobility based on the selected mobility area descriptor. The mobile device 110 selects the geographical area associated with the mobility area descriptor and considers such geographical area as an optimal area for communication with the access point 140.

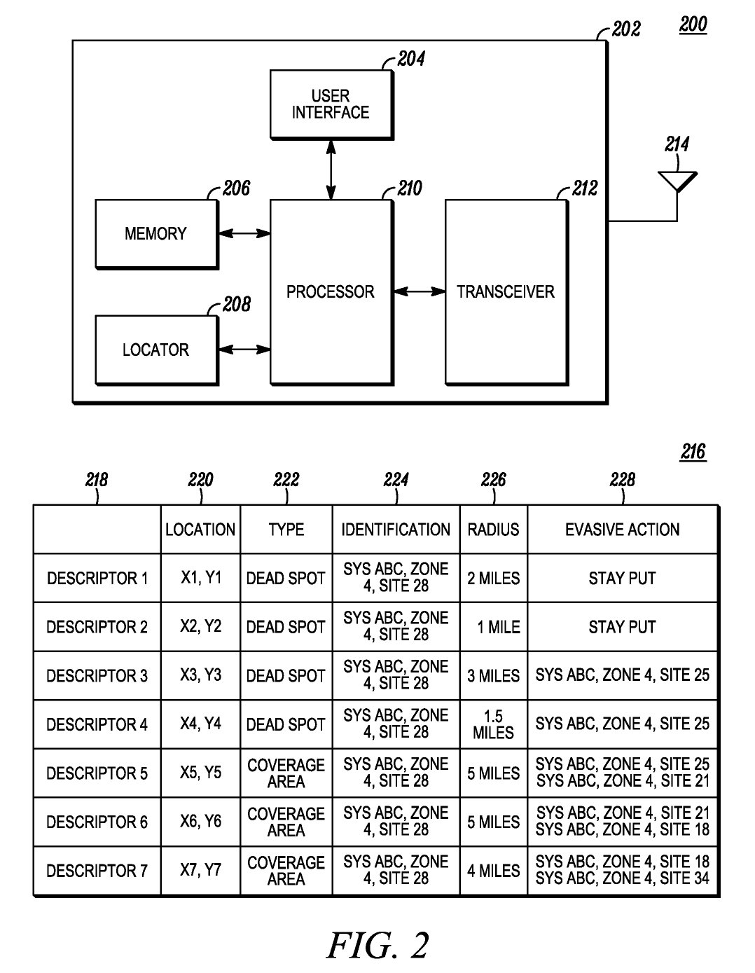

FIG. 2 is a block diagram illustrating exemplary internal components of a mobile device 200 in accordance with some embodiments of the invention. The exemplary components include a user interface 204, a memory 208, a locator 206, a processor 210, a transceiver 212, and an antenna 214. Although not shown, the user interface 204 may include an input device and an output device. In one embodiment, the input device may be used to connect an external device 230 to the mobile device 110.

In accordance with an embodiment, the memory 208 is coupled to the processor 210 of the mobile device 200 to store the mobility area descriptors received from the external device 230 communicatively coupled to the mobile device 200. The external device 230 may be a device that has “mobile device configuration software (MDCS)” and can upload user required mobility area descriptors into the mobile device 200. In another embodiment, the external device may be a device of a communication system such as an access point that can communicate and update the mobility descriptors in the mobile device via a control channel. The memory 208 in the mobile device 200 receives recently changed mobility area descriptors from the access point at a higher priority and the stable mobility area descriptors at a lower priority. The memory 208 accordingly updates the stored mobility area descriptors with the received mobility area descriptors.

Each mobility area descriptor is associated with the corresponding geographical area in the communication system 100. The geographical area may be a coverage area or a dead spot. The mobility area descriptors are described in detail with reference to a table 216 of FIG. 2. Table 216 illustrates the plurality of mobility area descriptors stored in the memory 208 of the mobile device 200. In one embodiment, the table 216 may be stored in the external device 230 and the mobile device may receive and store such table 216 from the external device 230. In table 216, the mobility area descriptor 1 is associated with the dead spot 122, the mobility area descriptor 2 is associated with the dead spot 124, and the mobility area descriptor 3 is associated with the dead spot 120. Similarly, the mobility area descriptor 4 is associated with the dead spot 118, the mobility area descriptor 5 is associated with the coverage area 112, the mobility area descriptor 6 is associated with the coverage area 114, and the mobility area descriptor 7 is associated with the coverage area 116.

Further, each mobility area descriptor contains information or parameters related to the corresponding geographical area. The parameters include location 220 of the geographical area, type 222 of the geographical area, identification 224 of the geographical area, radius 226 of the geographical area, and an evasive action 228 in the geographical area. For simplicity, the parameters are described with reference to the geographical area 112. The location 220 of the geographical area 112 indicates central position coordinates, for example X₁,Y₁, of the geographical area 112. In one embodiment, the central position coordinates X₁,Y1 of the geographical area 112 is determined by employing the GPS tracking system. The type 222 of the geographical area 112 indicates whether the geographical area 112 is a coverage area or a dead spot.

The identification 224 of the geographical area 112 includes a system, a zone, and the site that bears the geographical area 112. For example, in reference to FIG. 1, the system ABC of table 216 is represented as wireless communication system 100, similarly, zone 4 is shown as zone 4 (not shown), and site 28 is shown as site 102.

The radius 226 indicates a distance between the central position coordinates, for example X₅,Y₅, and the edge of the geographical area 112. In one embodiment, the radius 226, for example 5 miles, is utilized to determine a boundary or circumference of the geographical area 112.

The evasive action 228 is a decision taken by the mobile device 200 when the mobile device 200 faces communication problems in the current geographical area. For example, the mobile device 200 may decide to leave the current geographical area 112 or continue communication in the current geographical area 112 based on the information present in the evasive action.

The evasive action 228 includes either a stay action or a leave action. The stay action indicates that the mobile device continues to communicate over a first control channel associated with a first site 102, instead of trying to search for a better site. The leave action indicates that the mobile device communicates over a second control channel associated with a second site (not shown). The leave action includes identity of sites adjacent to the first site. For example, in table 216, the evasive action 228 in the descriptor 5 is a leave action that includes identity of adjacent sites 25 and 21.

Further, moving back to the internal components of the mobile device 200, the locator 206 is coupled to the processor 210 that identifies a current location of the mobile device 200. The locator 206 includes a GPS tracking onboard receiver for determining the current location of the mobile device 200. In an alternate embodiment, the locator 206 includes, but is not limited to, a triangulation receiver, an accelerometer, a gyroscope, or any other information collecting device that may identify the current location of the mobile device 200. In one embodiment, the location information of the mobile device 200 is utilized for selecting a mobility area descriptor associated with a coverage area proximity to the mobile device 110.

In accordance with the embodiment, the transceiver 212 coupled to the processor enables the mobile device 200 to communicate with at least one access point. Due to the mobile nature of the mobile device 200, the transceiver 212 should be wireless. An exemplary function of the mobile device 200 as represented by the block diagram, upon reception of wireless signals via the antenna 214, the transceiver 212 demodulates the communication signals to recover incoming information, such as voice and/or data, transmitted by the wireless signals. Specifically, the incoming information contains the plurality of mobility area descriptors 216.

Operationally, the processor 210 is coupled to the user interface 204, the locator 206, the memory 208, and the transceiver 212. The processor 210 may perform various operations to store, manipulate and retrieve the mobility area descriptors in the memory 208. The processor 210 employs locator 206 to determine the current location of the mobile device 200. The processor 210 then selects a mobility area descriptor 216 among the plurality of mobility area descriptors 216 stored in the memory 208 based on the current location of the mobile device 200. The processor matches the determined location of the mobile device with the location parameter 220 of each of the mobility area descriptors, and selects the mobility area descriptor that has location, associated with the coverage area, proximity to the current location of the mobile device 110. In an alternative embodiment, the processor selects the mobility area descriptor based on the information related to the radius, type, and location of the mobility area descriptor.

Upon selecting the mobility area descriptor, the processor 210 optimizes the mobility of the mobile device 200 based on the selected mobility area descriptor. The processor optimizes the mobility of the mobile device based on the evasive action in the selected mobility area descriptor.

In accordance with the embodiment, the antenna 214 comprises any known or developed structure for radiating and receiving electromagnetic energy in the frequency range containing the wireless carrier frequencies. Each component of the mobile device 200 is not limited to a single component but represents functions that may be performed by a single component or multiple cooperative components, such as a central processing unit operating in conjunction with a digital signal processor and one or more input/output processors. Likewise, two or more components of the mobile device 200 may be combined or integrated so long as the functions of these components may be performed by the communication device.

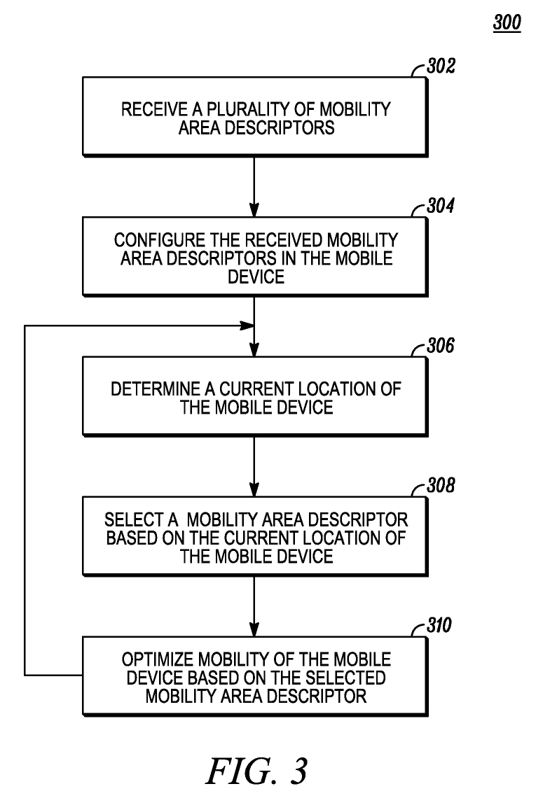

FIG. 3 is a flowchart of a method for optimizing mobility of a mobile device in accordance with some embodiments. Please note that the method 300 is described from the perspective of mobile device 110 shown in FIG. 1. Referring to FIG. 3, the method begins with a step of receiving 302 the plurality of mobility area descriptors 216. The mobility area descriptor is received from an external device having mobile device configuration software (MDCS). In another embodiment, the mobility area descriptor is received from an access point 140 via a control channel.

Upon receiving the plurality of mobility area descriptors 216, the method continues with a step of configuring 304 the received plurality of mobility area descriptors in the mobile device 200. The step of configuring 304 the mobility area descriptors includes prioritizing (sorting) the dead spot descriptors ahead of the coverage area descriptors, and further prioritizing dead spot descriptors with stay evasive actions over dead spots with leave evasive actions. In one embodiment, the step of configuring 304 may include updating at least a portion of mobility area descriptors in the mobile device 110 that is corresponding to the received plurality of mobility area descriptors.

The method 300 then continues with a step of determining 306 a current location of the mobile device 110. In one embodiment, the current location of the mobile device is determined based on a position of a GPS tracking onboard receiver in the mobile device. Further, upon determining the current location of the mobile device, the method continues with a step of selecting 308 a mobility area descriptor among the plurality of mobility area descriptors based on the current location of the mobile device 110. The mobility area descriptor is associated with a geographical area 112 in the communication system 100. For example, the mobility area descriptor 5, shown in FIG. 2, is associated with a coverage area 112.

The mobility area descriptor is selected based on the comparison between the current location of the mobile device and the location 220 and radius 226 information of the geographical area in the mobility area descriptor.

Upon selecting the mobility area descriptor, the method 300 continues with a step of optimizing 310 the mobility of the mobile device 110 based on the selected mobility area descriptor. The mobile device optimizes its mobility based on an evasive action in the selected mobility area descriptor. For example, the evasive action may be a leave action which indicates that the mobile device should leave the current control channel associated with the current geographical area or current site and move to a new control channel associated with a new site adjacent to the current site in the communication system. In another example, the evasive action may be a stay action which indicates that the mobile device should stay in the same geographical area and continue communication with the access point on the current control channel.

Further, the method 300 continues to repeat from the step of determining 306 the current location to the step of optimizing 310 mobility of the mobile device, whenever the mobile device moves from the current location to a new location in the communication system.

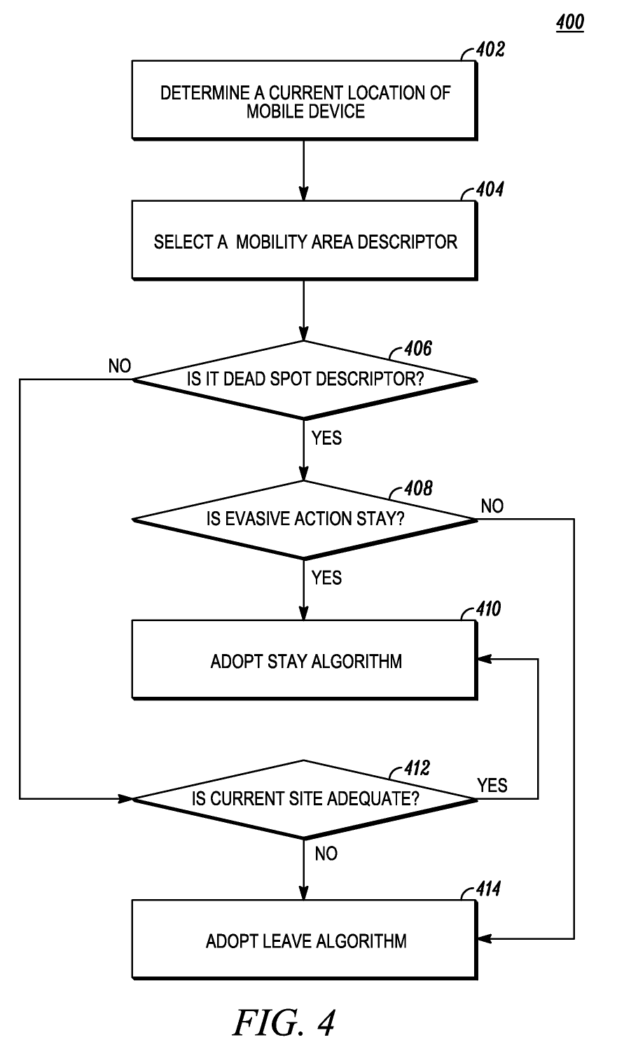

FIG. 4 is a detailed flow chart of the method to optimize the mobility of the mobile device 110. FIG. 4 elaborates the steps 306-310 of FIG. 3. Referring to FIG. 4, the method 400 starts with a step of determining 402 the current location of the mobile device 110. Please note that the FIG. 4 is described in reference to the internal components of the mobile device shown in FIG. 2. The processor 210 of the mobile device 110 utilizes the locator 206 to determine the current location of the mobile device 110. For example, the locator 206 may employ onboard GPS tracking receiver to determine the current location of the mobile device 110. The method 400 then continues with a step of selecting 404 a mobility area descriptor among the plurality of mobility area descriptors stored in the memory 208 of the mobile device 110. The processor 210 of the mobile device 110 selects a particular mobility area descriptor and analysis the parameters stored in the selected mobility area descriptor.

The method 400 then continues with a step of processor determining 406 whether the type 222 of geographical area associated with the selected mobility area descriptor is a dead spot. If the geographical area is determined to be a dead spot, the method continues with a step of processor determining 408 whether the evasive action 228 within the selected mobility area descriptor is a stay action. The evasive action 228 is a stay action when the dead spot is located only in the first site, for example dead spot 124 in site 102, and is not a part of any other adjacent site. If the evasive action 228 is determined to be a stay action, the method further continues with a step of adopting 410 a stay algorithm. For example, the selected mobility area descriptor 2 from the table 216 contains the following information:

| | |
|---|---|
| Location: | X2, Y2 |
| Type: | Dead spot |
| Identification: | Sys ABC, Zone 4, Site 28 |
| Radius: | 1 mile |
| Evasive Action: | Stay put |

In the above shown example, since the evasive action is “stay put,” the mobile device 200 adopts the stay algorithm and continues to communicate over the control channel of current site 28.

On the other hand, at step of determining 408, if the processor 210 determines that the evasive action 228 within the selected mobility area descriptor is not a stay action then the method 400 continues with a step of processor 210 adopting 414 a leave algorithm. In one embodiment, the evasive action 228 does not include a stay action when a portion of the dead spot is located in the second site, in addition to dead spot being located in the first site. For example, the selected mobility area descriptor 3 from the table 216 contains the following information:

| | |
|---|---|
| Location: | X3, Y3 |
| Type: | Dead spot |
| Identification: | Sys ABC, Zone 4, Site 28 |
| Radius: | 3 miles |
| Evasive Action: | Sys ABC, Zone 4, Site 25 |

In the above shown example, since the evasive action has information of the adjacent site 25, the mobile device 200 adopts the Leave algorithm and attempts to leave the control channel of site 28 to communicate over a control channel of site 25.

Further, moving back to the step of determining 406 of the method 400, if the processor 210 determines 406 that the geographical area associated with the selected mobility area descriptor is not a dead spot, the method moves to the step of processor determining 412 whether the signals from the current site are adequate for communication with the access point. If the signals from the current site are determined to be adequate, the method continues moves to the step of processor adopting 410 the Stay algorithm.

On the other hand, at step of determining 412 whether the signals from the current site are adequate, if the signals from the current site are determined not to be adequate for communication, the method moves to the step of adopting 414 the Leave algorithm. For example, the selected mobility area descriptor 5 from the table 216 contains the following information:

| | |
|---|---|
| Location: | X5, Y5 |
| Type: | Coverage Area |
| Identification: | Sys ABC, Zone 4, Site 28 |
| Radius: | 5 miles |
| Evasive Action: | Sys ABC, Zone 4, Site 25 |
| | Sys ABC, Zone 4, Site 21 |

In the above shown example, the mobile device 200 adopts the Leave algorithm and attempts to leave the control channel of site 28 and communicate over the control channel of sites listed in the evasive action. In one embodiment, the processor analysis the RSSI measurement in each of the sites listed and selects a particular site that has maximum RSSI measurement. Thus, the mobile device optimizes its mobility based on the parameters of the mobility area descriptors stored in the mobile device.

Thus, the location based mobility area descriptor information is used by the mobile device to ensure that the mobile device spends most of its time attempting to decode the current site in order to maximize its ability to accept and initiate communications under poor coverage conditions. Furthermore, the mobility area descriptor information can ensure that the recovery from the dead spot is as fast as the signal conditions allow, and that the current site is not penalized.

Also, location based mobility area descriptor information can be used by the mobile device to instantly choose the site with the most optimal outbound and inbound coverage.

In conclusion, the aim of the location based mobility area descriptor information is to ensure the best possible inbound and outbound communication by minimizing the amount of searching that the mobile device does under different site switching conditions, and in turn maximizing the time spent on the most optimal control channel.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method of operating a mobile device to optimize mobility of the mobile device (110) in a communication system (100), the method comprising:
receiving (302) a plurality of mobility area descriptors;
configuring (304) the received plurality of mobility area descriptors in the mobile device;
determining (306) a current location of the mobile device (110);
selecting (308) a mobility area descriptor among the plurality of mobility area descriptors based on the current location of the mobile device (110), wherein the mobility area descriptor is associated with a geographical area (112) in the communication system; and
optimizing (310) the mobility of the mobile device (110) based on the selected mobility area descriptor.

2. The method of claim 1, wherein the geographical area (112) includes one of a coverage area (116) and a dead spot (128).

3. The method of claim 1, wherein receiving the plurality of mobility area descriptors comprises receiving the plurality of mobility area descriptors from an external device having mobile device configuration software (MDCS).

4. The method of claim 1, wherein receiving the plurality of mobility area descriptors comprises receiving the plurality of mobility area descriptors from an access point (104) via a first control channel.

5. The method of claim 1, wherein configuring the received plurality of mobility area descriptors comprises updating at least a portion of mobility area descriptors in the mobile device (110) that is corresponding to the received plurality of mobility area descriptors.

6. The method of claim 1, wherein determining the current location of the mobile device comprises determining the current location of the mobile device based on a position of a global positioning system (GPS) tracking onboard receiver.

7. The method of claim 1, wherein the mobility area descriptor includes information related to at least one of:
a location of the geographical area (112), wherein the location indicates central position coordinates of the geographical area (112);
a type of the geographical area (112), wherein the type indicates one of a coverage area and a dead spot (128);
an identity of the geographical area, wherein the identity includes at least one of a region, a zone, and a first site (102) bearing the geographical area (112);
a radius of the geographical area, wherein the radius indicates a distance between the central position coordinates and an edge of the geographical area (112); and
an evasive action in the geographical area, wherein the evasive action includes one of a stay action and a leave action.

8. The method of claim 7, wherein the stay action indicates that the mobile device (110) continuous to communicate via a first control channel associated with the first site (102).

9. The method of claim 7, wherein the leave action indicates that the mobile device attempts to communicate via a second control channel associated with a second site.

10. The method of claim 7, wherein the evasive action includes the stay action when the geographical area is a dead spot and the geographical area is located only in the first site.

11. The method of claim 7, wherein the evasive action includes the leave action when the geographical area is a dead spot and at least a portion of the geographical area is located in a second site.

12. The method of claim 7, wherein the evasive action includes the leave action when the geographical area is a coverage area.

13. The method of claim 7, wherein the leave action includes identity of at least one site adjacent to the first site (102).

14. The method of claim 1, wherein selecting (308) the mobility area descriptor comprises selecting the mobility area descriptor having a location associated with the geographical area proximity to the determined current location of the mobile device (110).

15. The method of claim 1, wherein optimizing (310) the mobility of the mobile device comprises optimizing the mobility of the mobile device based on the evasive action in the selected mobility area descriptor.

16. An apparatus for optimizing the mobility of the mobile device in a communication system, the apparatus comprising:
a locator (208) for determining a current location of the mobile device (200);
a memory (206) for storing a plurality of mobility area descriptors; and
a processor (210), coupled to the locator (208) and the memory (206), for selecting a mobility area descriptor among the plurality of mobility area descriptors based on the current location of the mobile device (200), and optimizing the mobility of the mobile device based on the selected mobility area descriptor, wherein the mobility area descriptor is associated with a geographical area in the communication system.

17. The apparatus of claim 16 further comprising a transceiver (212) for receiving the plurality of mobility area descriptors from an external device.

18. The apparatus of claim 16, wherein the locator (208) is a global positioning system (GPS) tracking onboard receiver.

19. The apparatus of claim 16, wherein, the processor (210) optimizes the mobility of the mobile device based on an evasive action status of the selected mobility area descriptor, wherein the evasive action status indicates one of a stay action status and a leave action status.

20. The apparatus of claim 16, wherein the stay action status indicates that the processor (210) continuous to monitor a first control channel associated with a first site, wherein the first site includes the geographical area.

21. The apparatus of claim 16, wherein the leave action indicates that the processor (210) attempts to monitor a second control channel associated with a second site, wherein the second site is located adjacent to the first site.
